(19) United States
(12) Patent Application Publication
(10) Pub. No.: US 2012/0054439 A1
(43) Pub. Date: Mar. 1, 2012

(54) METHOD AND APPARATUS FOR ALLOCATING CACHE BANDWIDTH TO MULTIPLE PROCESSORS

(76) Inventor: William L. Walker, Fort Collins, CO (US)

(21) Appl. No.: 12/862,286

(22) Filed: Aug. 24, 2010

(51) Int. Cl. G06F 12/08; G06F 12/00

(52) U.S. Cl. 711/122; 711/141; 711/E12.001; 711/E12.026; 711/E12.024

(57) ABSTRACT

The present invention provides a method and apparatus for allocating cache bandwidth to multiple processors. One embodiment of the method includes delaying, at a local device associated with a local cache, a first cache probe from a non-local device to the local cache following a second cache probe from the non-local device that matches a third cache probe from the local device.

### BACKGROUND OF THE INVENTION

1. Field of the Invention

This invention relates generally to processor-based systems, and, more particularly, to allocating cache bandwidth in processor-based systems.

2. Description of the Related Art

Many processing devices utilize caches to reduce the average time required to access information stored in a memory. A cache is a smaller and faster memory that stores copies of instructions and/or data that are expected to be used relatively frequently. For example, central processing units (CPUs) are generally associated with a cache or a hierarchy of cache memory elements. Instructions or data that are expected to be used by the CPU are moved from (relatively large and slow) main memory into the cache. When the CPU needs to read or write a location in the main memory, it first checks to see whether the memory location is included in the cache memory. If this location is included in the cache (a cache hit), then the CPU can perform the read or write operation on the copy in the cache memory location. If this location is not included in the cache (a cache miss), then the CPU needs to access the information stored in the main memory and, in some cases, the information can be copied from the main memory and added to the cache. Proper configuration and operation of the cache can reduce the latency of memory accesses below the latency of the main memory to a value close to the value of the cache memory.

One widely used architecture for a CPU cache memory divides the cache into two layers that are known as the L1 cache and the L2 cache. The L1 cache is typically a smaller and faster memory than the L2 cache, which is smaller and faster than the main memory. The CPU first attempts to locate needed memory locations in the L1 cache and then proceeds to look successively in the L2 cache and the main memory when it is unable to find the location in the cache. The L1 cache can be further subdivided into separate L1 caches for storing instructions (L1-I) and data (L1-D). The L1-I cache can be placed near entities that require more frequent access to instructions than data, whereas the L1-D can be placed closer to entities that require more frequent access to data than instructions. The L2 cache is associated with both the L1-I and L1-D caches and can store copies of information or data that are retrieved from the main memory. Frequently used instructions are copied from the L2 cache into the L1-I cache and frequently used data can be copied from the L2 cache into the L1-D cache. The L2 cache is therefore often referred to as a unified cache.

Computer systems can also employ multiple processors that access instructions and data stored in a single main memory. For example, a main memory and multiple processors can be interconnected using a bridge or a bus. Each of the processors maintains its own cache memory hierarchy, which may include L1-I, L1-D, and L2 caches. In order to maximize the cached information content, the bridge is responsible for synchronizing the different caches so that information is not duplicated in the lines of caches associated with different processors. The processors can send cache requests over the bridge to any of the available cache memory elements. Consequently, each processor is able to make cache requests to its own cache hierarchy and to receive cache requests from other processors via the bridge. Cache requests received from the bridge are given higher priority than local cache requests generated by the processor associated with the cache. A steady stream of cache requests from external processors can therefore starve a local processor of cache bandwidth, which may prevent forward progress by the local processor.

### SUMMARY OF EMBODIMENTS OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for allocating cache bandwidth to multiple processors. One embodiment of the method includes delaying, at a local device associated with a local cache, a first cache probe from a non-local device to the local cache following a second cache probe from the non-local device that matches a third cache probe from the local device.

In another embodiment, an apparatus is provided for allocating cache bandwidth to multiple processors. One embodiment of the apparatus includes a cache arbiter configured for implementation in a local device. The cache arbiter is configured to delay a first cache probe from a non-local device to a local cache following a second cache probe from the non-local device that matches a third cache probe from the local device.

In yet another embodiment, a system is provided for allocating cache bandwidth to multiple processors. One embodiment of the system includes a bridge and a plurality of processors communicatively coupled to the bridge. Each processor is associated with one or more caches. The system also includes one or more cache arbiters implemented in one or more of the plurality of processors. Each cache arbiter is configured to delay a first cache probe received via the bridge following a second cache probe received via the bridge that matches a third cache probe from the processor that implements the cache arbiter.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a computer system;

FIG. 2 conceptually illustrates a second exemplary embodiment of a computer system;

FIGS. 3A and 3B conceptually illustrate first and second sequences of events during concurrent local and non-local cache probe operations; and

FIGS. 4A and 4B conceptually illustrate third and fourth sequences of events during concurrent local and non-local cache probe operations.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

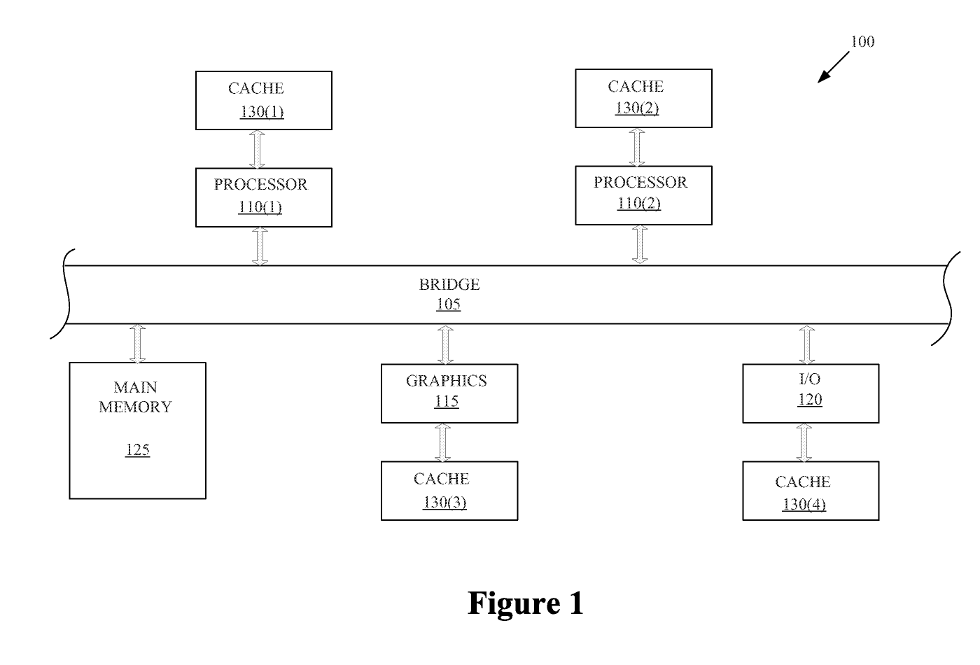

FIG. 1 conceptually illustrates a first exemplary embodiment of a computer system 100. In the illustrated embodiment, the computer system 100 includes a bus or a bridge 105 that is used to support communication between various elements that are communicatively and/or electronically connected to the bridge 105. Exemplary bridges 105 include, but are not limited to, north bridges, south bridges, and other buses and/or bridges that are used to facilitate communications between elements in computer systems. Techniques for constructing, configuring, and/or operating the bridge 105 are known in the art and in the interest of clarity only those aspects of the construction, configuration, and/or operation of the bridge 105 that are relevant to the claimed subject matter are discussed in detail herein.

The computer system 100 depicted in FIG. 1 is a multiprocessor device that includes two processors 110(1-2) that are communicatively and/or electronically coupled to the bridge 105. The processors 110(1-2) can therefore communicate with each other by exchanging signals and/or messages over the bridge 105. Additional devices can also be coupled to the bridge 105, e.g., a graphics card 115, one or more input/output devices 120, and the like. Persons of ordinary skill in the art having benefit of the present disclosure should appreciate that the computer system 100 is intended to be illustrative and alternate embodiments of the computer system 100 may include different numbers of processors 110, graphics cards 115, I/O devices 120, and/or any other type of device that can communicatively and/or electronically coupled to the bridge 105.

A main memory element 125 is also communicatively and/or electronically coupled to the bridge 105. The processors 110, graphics cards 115, and/or I/O devices 120 can therefore access information in the main memory 125 by exchanging signals and/or messages with the main memory 125 via the bridge 105. The information in the main memory 125 may include instructions and/or data. Accessing information in the main memory 125 may include reading information from the memory 125, writing information to the memory 125, and/or modifying the contents of one or more locations in the memory 125. Although a single main memory element 125 is depicted in FIG. 1, persons of ordinary skill in the art having benefit of the present disclosure should appreciate that alternative embodiments of the computer system 100 may include multiple memory elements 125 that may be communicatively and/or electronically connected to the bridge 105 and/or to each other.

The processors 110, graphics cards 115 and/or I/O devices 120 may each maintain cache memory elements 130(1-4) for storing copies of information retrieved from the main memory 125. The cache memory elements 130 may be formed using faster and/or smaller memory devices and may be located physically closer to their associated device to reduce latency of memory accesses. The cache memory elements 130 can store instructions used by the associated devices and/or data used by the associated devices. In one embodiment, the computer system 100 implements a coherent memory fabric in which functionality/logic in the bridge 105 coordinates operation of the main memory 125 and the cache memory elements 130 so that the information in these elements is logically ordered and/or integrated. For example, the bridge 105 may coordinate operation of the memory elements 125, 130 so that the contents of any particular location in the main memory 125 are only stored in a single cache memory 130. Preventing duplication of information in the coherent memory fabric including the main memory 125 and the cache memory 130 may improve overall access speed and reduce the overall memory latency because a larger fraction of the locations in the main memory 125 can be copied into the cache elements 130.

The devices 110, 115, 120 may be configured to probe caches associated with other devices. For example, if the processor 110(1) probes its own cache 130(1) and is unable to find the requested copy of the information from the main memory 125, the processor 110(1) may transmit a probe (or probe request) over the bridge 105 to the processor 110(2), which may convey this probe to its associated cache 130(2). Cache probes can therefore be separated into local probes and non-local probes. As used herein, the term “local probe” will be used to refer to a probe generated by a device to probe its associated cache memory. The device performing the probe may also be referred to as a “local device.” The term “non-local probe” will be used to refer to a probe received by a first device from a second device and used to probe the cache memory associated with the first device. The first device may therefore be referred to as a “local device” and the second device may be referred to as a “non-local device.” In one embodiment, probes received by a device from the bridge 105 are identified as non-local probes. Thus, probes can be identified as non-local probes without necessarily knowing which device generated the non-local probe. The local device may also be configured to return results of the probe, such as contents of the probed location (e.g., a line or a way indicated by tags) in the cache to other elements such as the devices 110, 115, 120.

Non-local probes may be given higher priority (relative to local probes) by a device. For example, if a cache arbiter in the processor 110(2) is processing both a local probe generated by the processor 110(2) and a non-local probe received via the bridge 105, the cache arbiter may allow the non-local probe to proceed before allowing the local probe to proceed. A persistent stream of non-local probes going into a local processor 110 from the bridge 105 can starve the local processor 110 of cache bandwidth, thereby preventing forward progress of the local processor 110. In one embodiment, the cache arbiter can therefore make one or more subsequent non-local probes wait for a selected number of cycles before arbitrating for access to the cache 130 when non-local probes have already won a selected number of consecutive cache arbitration rounds. The number of waiting cycles and/or the number of consecutive wins can be set based on statistical measures such as a cache bandwidth available to the non-local and/or local processor 110. In some embodiments, matches, contention, conflicts and/or hazard conditions between local and/or non-local requests can lead to more complicated states that can cause cache bandwidth starvation in ways that are not necessarily addressed by this arbitration technique. The cache arbiter may therefore delay a cache probe from a non-local processor 110 to a local cache 130 following a cache probe from the non-local processor 110 that matches a concurrent cache probe from the local processor 110. The delay can be determined based upon the context and/or hazard condition of the local and non-local cache probes, as discussed herein.

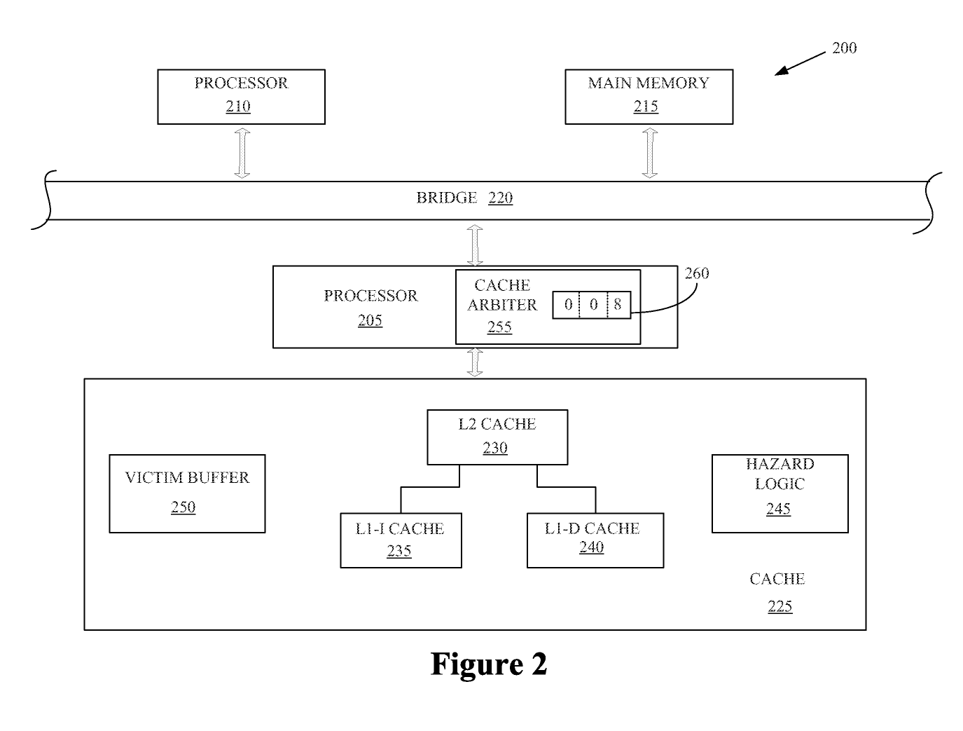

FIG. 2 conceptually illustrates a second exemplary embodiment of a computer system 200. In the illustrated embodiment, a processor 205, a processor 210, and a main memory 215 are communicatively coupled to a bridge 220. The processor 205 may be a central processing unit (CPU) 205 that is configured to access instructions and/or data that are stored in the main memory 215. The processor 205 is communicatively coupled to a cache system 225 that is used to speed access to the instructions and/or data by storing selected instructions and/or data in the caches. The illustrated cache system 225 includes a unified level 2 (L2) cache 230 for storing copies of instructions and/or data that are stored in the main memory 215. The illustrated cache system 225 also includes separate level 1 (L1) caches for storing instructions and data, which are referred to as the instruction-only L1-I cache 235 and the data-only L1-D cache 240. The cache system 225 also includes hazard logic 245 that can detect and resolve conflicts between requests. For example, the hazard logic 245 can detect matching addresses for two cache requests that are in-flight concurrently and then resolve the interference between these conflicting requests. One or more victim buffers 250 may also be included to temporarily store copies of information that has been evicted from one or more of the caches 230, 235, 240, e.g., in accordance with a replacement policy for the corresponding cache.

In the illustrated embodiment, the processor 205 is a local processor that includes a cache arbiter 255 for controlling and coordinating access to the cache system 225. The cache arbiter 255 can receive local probe requests from the processor 205 and non-local probe requests such as probe requests received from the processor 210 via the bridge 220. The cache arbiter 255 may assign a higher priority to non-local probe requests than to the local probe-requests. However, as discussed herein, the cache arbiter 255 may delay non-local probe requests under certain conditions. In one embodiment, the cache arbiter 255 may make non-local probes wait for a selected number of cycles before arbitrating for access to the cache 225 when non-local probes have already won a selected number of consecutive cache arbitration rounds. The selected number of cycles may be indicated by a backoff counter 260 that can count down the selected number of cycles. The cache arbiter 255 may also delay access to the caches 230, 235, 240 under other conditions including hazard conditions between local and non-local probes, data movements caused by downgrade probes, and the like.

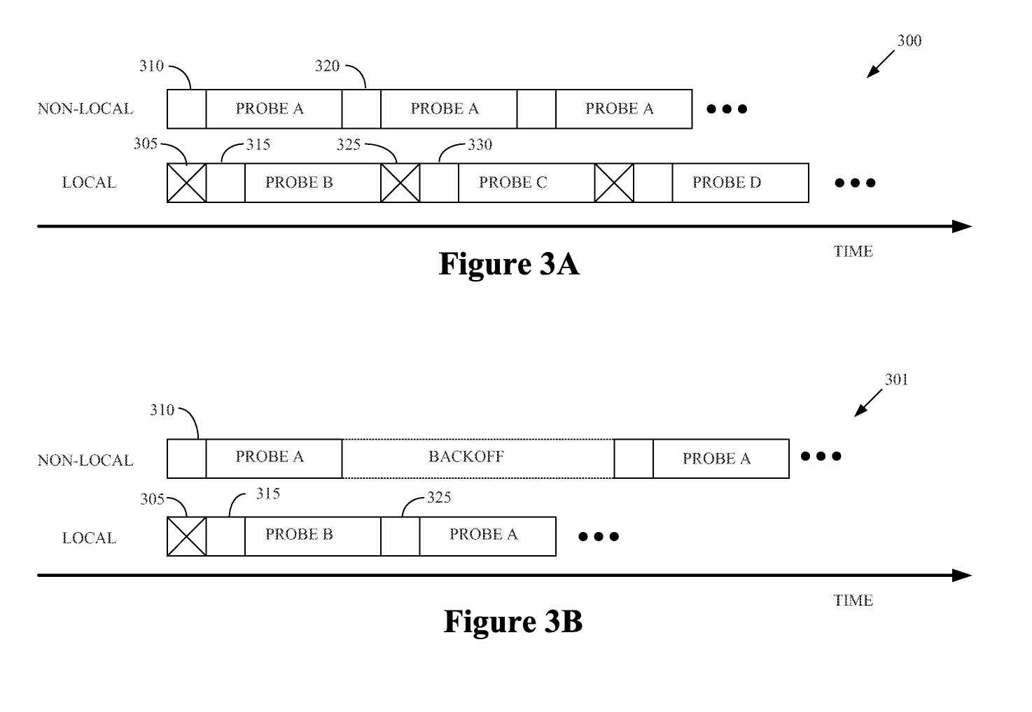

FIG. 3A conceptually illustrates a first sequence of events during concurrent local and non-local cache probe operations. The horizontal axis indicates increasing time in the direction of the arrow in arbitrary units. In the illustrated embodiment, a cache arbiter (such as the cache arbiter 255 shown in FIG. 2) detects concurrent local and non-local probe requests 305, 310 for the same location in a cache. This location is referred to in the illustrated embodiment as location “A.” A hazard condition is therefore detected, e.g., by the hazard logic 245 shown in FIG. 2. The cache arbiter gives higher priority to the non-local probe request 310 and so this request is granted and the non-local processor can perform the probe of location A. The lower priority local probe request 305 is not granted as indicated by the X in the box 305. In the illustrated embodiment, the local processor therefore performs an alternate operation such as requesting (at box 315) a probe of a different location “B.” The cache arbiter grants this request and the local processor performs the probe of location B.

When the first non-local probe A has completed, the non-local processor sends a request (at box 320) to perform in other non-local probe of location A. In the illustrated embodiment, the selected number of consecutive (non-local) arbitration wins has not been reached and the local processor is not arbitrating for access to location A because it remains occupied with probe B. The cache arbiter therefore grants the request and the non-local processor proceeds with the probe of location A. Upon completing the probe of location B, the local processor again requests (at box 325) a probe of location A. However, the non-local probe A is still proceeding and so this request is denied. The local processor may then initiate (at 330) a probe of a different location such as location C or D. This loop can proceed as long as the non-local processor (or any other device coupled to the bridge) continues to probe the same location A, thereby starving the local processor of access to the cache location.

FIG. 3B conceptually illustrates a second sequence 301 of events during concurrent local and non-local cache probe operations. The horizontal axis indicates increasing time in arbitrary units. As depicted in FIG. 3A, the cache arbiter detects concurrent local and non-local probe requests 305, 310 for location A in a cache. A hazard condition is therefore detected and the cache arbiter grants the higher priority non-local probe request 310 so that the non-local processor performs the probe of location A. The lower priority local probe request 305 is not granted as indicated by the X in the box 305. In the illustrated embodiment, the local processor performs an alternate operation such as requesting (at box 315) a probe of a different location “B.” The cache arbiter grants this request and the local processor performs the probe of location B.

When the first non-local probe A has completed, the cache arbiter determines that a hazard condition occurred and completion of the non-local probe A retired the hazard condition. The cache arbiter therefore enforces a backoff interval (e.g., a waiting period of a selected number of cycles or until some predetermined condition is satisfied) for non-local probes. Upon completing the probe of location B, the local processor again requests (at box 325) a probe of location A. In the illustrated embodiment, the non-local processor remains in the backoff state and so the local probe request is granted. The local processor may then perform the probe of location A, e.g., using the tags associated with the lines and/or ways in the cache. Implementing the post-hazard condition backoff for non-local probes can therefore provide local probes an opportunity to proceed so that the state of the local processor can progress.

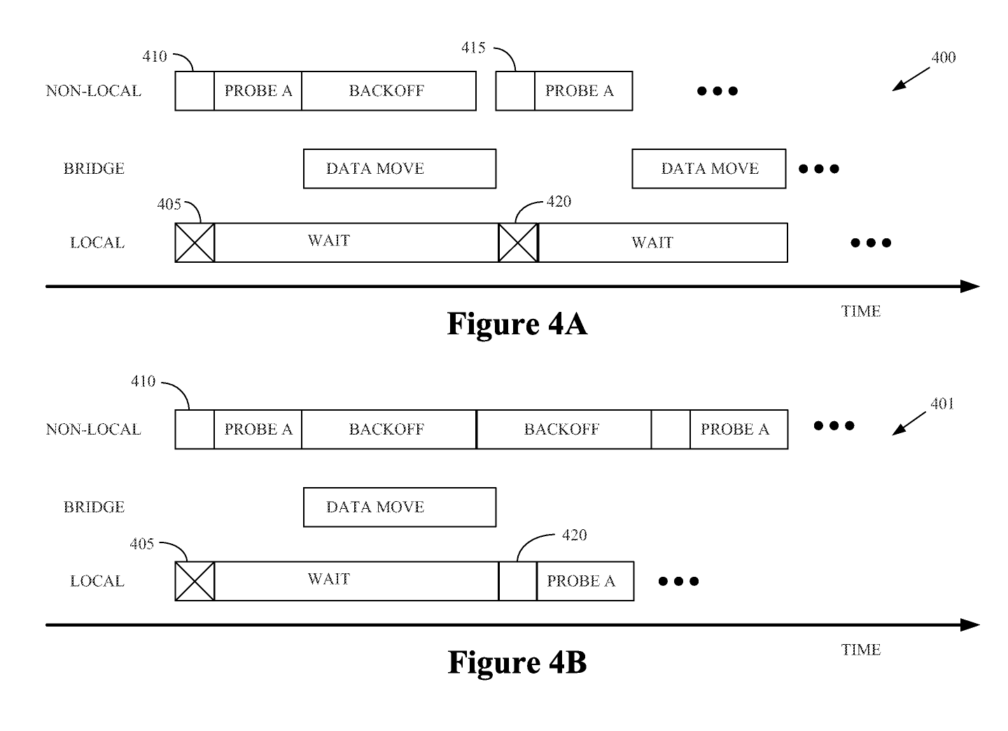

FIG. 4A conceptually illustrates a third sequence 400 of events during concurrent local and non-local cache probe operations. The horizontal axis indicates increasing time in arbitrary units. In the illustrated embodiment, the cache arbiter detects concurrent local and non-local probe requests 405, 410 for location A in a cache. The non-local probe request 410 is a downgrade probe, e.g., a probe that downgrades the cache location from exclusive access reserved for a single device to shared access by more than one device. The non-local probe request 410 is matched by a local probe request 405, which may result in a hazard condition. The cache arbiter grants the higher priority non-local probe request 410 and the non-local processor performs the probe of location A. The lower priority local probe request 305 is not granted as indicated by the X in the box 305. In the illustrated embodiment, the non-local downgrade probe results in a data movement that may be performed by the bridge. For example, data in the location A is written to a victim buffer and then copied back to the main memory when the probed location includes modified data (which may be indicated using a “dirty” bit at the location).

The local processor has to wait until the data movement has been completed before attempting to probe the location A. The non-local processor may also be in a backoff state, e.g., because of a consecutive number of non-local arbitration wins and/or as a result of a hazard condition retiring. However, in the illustrated embodiment, the duration of the data movement is long enough that the backoff interval expires before or at approximately the same time as the end of the data movement interval. The non-local process is therefore free to request additional probes of the location A. In the illustrated embodiment, the non-local processor requests (at 415) access to the location A before or at approximately the same time as the local processor requests (at 420) access to the same location. The cache arbiter therefore grants access to the higher priority non-local probe, thereby starving the local processor of cache bandwidth.

FIG. 4B conceptually illustrates a fourth sequence 401 of events during concurrent local and non-local cache probe operations. The horizontal axis indicates increasing time in arbitrary units. In the illustrated embodiment, the cache arbiter detects concurrent local and non-local probe requests 405, 410 for location A in a cache. As depicted in FIG. 4A, the non-local probe request 410 is a downgrade probe that is matched by a local probe request 405, which may result in a hazard condition. The cache arbiter grants the higher priority non-local probe request 410 and the non-local processor performs the probe of location A. The lower priority local probe request 405 is not granted as indicated by the X in the box 405. The non-local downgrade probe results in a data movement that may be performed by the bridge and the local processor has to wait until the data movement has been completed before attempting to probe the location A. The non-local processor may also be in a backoff state, e.g., because of a consecutive number of non-local arbitration wins and/or as a result of a hazard condition retiring.

In the illustrated embodiment, the duration of the data movement is long enough that the backoff interval expires before or at approximately the same time as the end of the data movement interval. However, the cache arbiter determines that a local probe request is waiting for a data movement to complete. The cache arbiter therefore extends the backoff interval for the non-local probe requests. The backoff interval can be extended by resetting a backoff counter and/or extending the backoff interval until a predetermined condition is satisfied. The local processor requests (at 420) access to the location A after the data movement has completed. The cache arbiter determines that there are no matching, competing, or conflicting requests from non-local processors (e.g., due to the extended backoff interval) and therefore permits the local processor to probe location A, e.g., using the tags associated with the lines and/or ways in the cache. Extending the backoff interval in response to detecting a probe request that is waiting for a data movement to complete can therefore provide cache bandwidth to local processors and allow the state of the local processor to progress.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation. Additionally, hardware aspects or embodiments of the invention could be described in source code stored on a computer readable media. In such an embodiment, hardware embodiments could be described by a hardware description language (HDL) such as Verilog or the like. This source code could then be synthesized and further processed to generate an intermediate representation (e.g., GDSII) data which is also stored on a computer readable media. Such source code is then used to configure a manufacturing process (e.g., a semiconductor fabrication facility or factory) through, for example, the generation of lithography masks based on the source code (e.g., the GDSII data). The configuration of the manufacturing process then results in a semiconductor device embodying aspects of the present invention.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
delaying, at a local device associated with a local cache, a first cache probe from a non-local device to the local cache following a second cache probe from the non-local device that matches a third cache probe from the local device.

2. The method of claim 1, comprising receiving the first and second cache probes from the non-local device at the local device via at least one of a bridge or a bus that communicatively couples the non-local device and the local device.

3. The method of claim 2, wherein the local device gives the first and second cache probes from the non-local device a higher priority than the third cache probe from the local device.

4. The method of claim 1, comprising determining that the second cache probe matches the third cache probe when the second cache probe and the third cache probe concurrently probe the same line or way of the local cache.

5. The method of claim 1, wherein the second and third cache probes trigger a hazard condition indicating that the second and third cache probes are concurrently in-flight, and wherein delaying the first cache probe comprises holding the first cache probe for a selected number of cycles after the second cache probe retires.

6. The method of claim 5, wherein holding the first cache probe for the selected number of cycles comprises holding the first cache probe for a number of cycles selected to allow the third cache probe to proceed before the first cache probe.

7. The method of claim 1, wherein the first and second cache probes are downgrade probes of a modified line of the cache so that the first and second cache probes cause the modified line to be written to a victim buffer.

8. The method of claim 7, wherein delaying the first cache probe comprises delaying the first cache probe while the third cache probe to the modified line of the cache remains pending.

9. The method of claim 7, wherein delaying the first cache probe comprises delaying the first cache probe for a number of cycles indicated by a counter that begins counting when the second cache probe causes a data movement and resetting the counter if it expires while the third cache probe remains pending until the data movement is completed.

10. An apparatus, comprising:
a cache arbiter configured for implementation in a local device, the cache arbiter being configured to delay a first cache probe from a non-local device to a local cache following a second cache probe from the non-local device that matches a third cache probe from the local device.

11. The apparatus of claim 10, wherein the cache arbiter is configured to receive the first and second cache probes from the non-local device at the local device via at least one of a bridge or a bus that communicatively couples the non-local device and the local device.

12. The apparatus of claim 11, wherein the local device is configured to give the first and second cache probes from the non-local device a higher priority than the third cache probe.

13. The apparatus of claim 10, wherein the cache arbiter is configured to determine that the second cache probe matches the third cache probe when the second cache probe and the third cache probe concurrently probe the same line of the local cache.

14. The apparatus of claim 10, comprising a hazard detector configured to trigger a hazard condition when the second and third cache probes are concurrently in-flight, and wherein the cache arbiter is configured to hold, in response to the hazard condition, the first cache probe for a selected number of cycles after the second cache probe retires.

15. The apparatus of claim 14, wherein the cache arbiter is configured to hold the first cache probe for a number of cycles selected to allow the third cache probe to proceed before the first cache probe.

16. The apparatus of claim 10, wherein the first and second cache probes are downgrade probes of a modified line of the local cache so that the first and second cache probes cause the modified line to be written to a victim buffer.

17. The apparatus of claim 16, wherein the cache arbiter is configured to hold the first cache probe while the third cache probe to the modified line of the local cache remains pending.

18. The apparatus of claim 16, wherein the cache arbiter is configured to hold the first cache probe for a number of cycles indicated by a counter that begins counting when the second cache probe causes a data movement and wherein the cache arbiter is configured to reset the counter if it expires while the third cache probe remains pending until the data movement is completed.

19. A system, comprising:
a bridge;
a plurality of processors communicatively coupled to the bridge, wherein each processor is associated with at least one cache;
at least one cache arbiter implemented in at least one of the plurality of processors, said at least one cache arbiter being configured to delay a first cache probe received via the bridge following a second cache probe received via the bridge that matches a third cache probe from the processor that implements said at least one cache arbiter.

20. The system of claim 19, wherein said at least one cache is at least one of an L1 cache for instructions, an L1 cache for data, or an L2 cache.

21. A computer readable media including instructions that when executed can configure a manufacturing process used to manufacture a semiconductor device comprising:
a cache arbiter configured for implementation in a local device, the cache arbiter being configured to delay a first cache probe from a non-local device to a local cache following a second cache probe from the non-local device that matches a third cache probe from the local device.

22. The computer readable media set forth in claim 21, wherein the computer readable media is configured to store at least one of hardware description language instructions or an intermediate representation.

23. The computer readable media set forth in claim 21, wherein the instructions when executed configure generation of lithography masks.
